(19) United States
(12) Patent Application Publication
(10) Pub. No.: US 2026/0118537 A1
(43) Pub. Date: Apr. 30, 2026

(54) METHODS AND SYSTEMS FOR LEAST-SQUARES WAVE-EQUATION KIRCHHOFF MIGRATION USING WAVE PROPAGATION

(71) Applicant: BP Corporation North America Inc., Houston, TX (US)

(72) Inventors: Hu Jin, Houston, TX (US); John Etgen, Houston, TX (US)

(73) Assignee: BP Corporation North America Inc., Houston, TX (US)

(21) Appl. No.: 19/352,749

(22) Filed: Oct. 8, 2025

Related U.S. Application Data
(60) Provisional application No. 63/711,281, filed on Oct. 24, 2024.

(51) Int. Cl. G01V 1/30; G01V 1/28

(52) U.S. Cl. CPC G01V 1/305; G01V 1/282; G01V 2210/673

(57) ABSTRACT

A computer-implemented method for determining modeled seismic data of a subsurface region includes receiving observed seismic data from the subsurface region captured by one or more seismic receivers as one or more reflected seismic signals; determining, based on a velocity model of the subsurface region and the observed seismic data, a traveltime function associated with the subsurface region; migrating, using the traveltime function and a Kirchhoff migration operator, the observed seismic data to produce a migrated seismic image; and performing reverse-time demigration on the migrated seismic image, using the velocity model and a solved full wave-equation, to produce modeled seismic data.

### CROSS-REFERENCE TO RELATED APPLICATIONS

This application is a non-provisional patent application which claims benefit of U.S. provisional patent application No. 63/711,281 filed Oct. 24, 2024, and entitled “Methods and Systems for Least Squares Wave Equation Kirchhoff Migration Using Wave Propagation,” which is hereby incorporated herein by reference in its entirety for all purposes.

### BACKGROUND

Seismic surveying is a method of exploration geophysics in which seismology is used to estimate properties of earthen subsurface regions from reflected seismic waves. Seismic surveying generally includes imparting acoustic or sound waves into a natural environment so that the waves enter the Earth and travel through a subsurface region of interest. As the seismic waves encounter an interface between two materials of the subsurface region, some of the wave energy is reflected off of the interface where the reflected wave energy may be observed or collected at the surface as seismic data associated with the subsurface region, while some of the wave energy refracts through the interface and penetrates deeper into the subsurface region. The reflected wave energy observed at the surface as seismic data may be studied to ascertain information about the subsurface region. For example, the observed seismic data may be used to construct a velocity model of the subsurface region which models the velocity of the seismic waves passing through the subsurface region so as to translate subsurface reflection points of the seismic waves to their true depth within the formation. The seismic data observed by the receivers may also be used to create an image or profile of the corresponding subsurface region. Interpretation of these seismic images may provide a description of the geological features of the subsurface, such as faults, salts domes, anticlines, or other features indicative of the location and/or change in hydrocarbon deposits.

### SUMMARY

Methods and systems for least-squares wave-equation Kirchhoff migration using wave propagation are disclosed herein. In an embodiment, a computer-implemented method for determining modeled seismic data of a subsurface region comprises (a) receiving observed seismic data from the subsurface region captured by one or more seismic receivers as one or more reflected seismic signals; (b) determining, based on a velocity model of the subsurface region and the observed seismic data, a traveltime function associated with the subsurface region; (c) migrating, using the traveltime function and a Kirchhoff migration operator, the observed seismic data to produce a migrated seismic image; and (d) performing reverse-time demigration on the migrated seismic image, using the velocity model and a solved full wave-equation, to produce modeled seismic data. In some embodiments, the method further comprises (e) comparing the modeled seismic data with the observed seismic data to determine residual seismic data; and (f) migrating, using the traveltime function and the Kirchhoff migration operator, the residual seismic data to determine one or more seismic gradients. In certain embodiments, the method comprises (g) applying the one or more seismic gradients to the migrated seismic image to determine an updated seismic image; and (h) stacking the updated seismic image to produce a seismic image representative of the subsurface region. In other embodiments, the method further comprises (i) iteratively repeating (e.g., in sequential order) steps (c)-(h) until the residual seismic data of a final iteration achieves a predefined magnitude to determine final residual seismic data whereby the seismic image of the final iteration corresponds to an output seismic image representative of the subsurface region. In some embodiments, (e) comprises determining a difference between the observed seismic data and the modeled seismic data. In certain embodiments, the traveltime function comprises a single-arrival traveltime function. In other embodiments, the traveltime function is estimated by picking the highest energy arrival from the full wave-equation modeling. In some embodiments, the reverse time demigration models full arrivals of the received seismic data. In certain embodiments, the method further comprises (e) applying a numerical algorithm of full wave-equation to estimate seismic data of the subsurface region. In other embodiments, the numerical algorithm comprises a finite difference method (FDM) algorithm. In some embodiments, iteratively repeating (e.g., in sequential order) the steps (c)-(h) until the residual seismic data of a final iteration achieves a predefined magnitude comprises comparing the modeled seismic data to the observed seismic data such that the output seismic image of the subsurface is iteratively shifted towards the observed seismic data. In certain embodiments, the migrated seismic image comprises an image gather and a stacked image.

In an embodiment, a system for determining modeled seismic data of a subsurface region comprises a one or more processors; and a storage device coupled to the one or more processors, the storage device configured to store instructions that, when executed by the one or more processors, configure the one or more processors to (a) receive observed seismic data from a subsurface region captured by one or more seismic receivers as one or more reflected seismic signals; (b) determine, based on a velocity model of the subsurface region and the observed seismic data, a traveltime function associated with the subsurface region; (c) migrate, using the traveltime function and a Kirchhoff migration operator, the observed seismic data to produce a migrated seismic image; and (d) perform reverse-time demigration on the migrated seismic image, using the velocity model and a solved full wave-equation, to produce modeled seismic data. In some embodiments, the instructions, when executed by the one or more processors, further configure the one or more processors to (e) compare the modeled seismic data with the observed seismic data to determine residual seismic data; and (f) migrate, using the traveltime function and the Kirchhoff migration operator, the residual seismic data to determine one or more seismic gradients. In certain embodiments, the instructions, when executed by the one or more processors, further configure the one or more processors to (g) apply the one or more seismic gradients to the migrated seismic image to produce an updated seismic image; and (h) stack the updated seismic image to produce a seismic image representative of the subsurface region. In other embodiments, the instructions, when executed by the one or more processors, further configure the one or more processors to (i) iteratively repeat (e.g., in sequential order) steps (c)-(h) until the residual seismic data of a final iteration achieves a predefined magnitude to determine final residual seismic data whereby the seismic image of the final iteration corresponds to an output seismic image representative of the subsurface region. In some embodiments, (e) comprises determining a difference between the observed seismic data and the modeled seismic data. In certain embodiments, the traveltime function comprises a single-arrival traveltime function. In other embodiments, the traveltime function is estimated by picking the highest energy arrival from the full wave-equation modeling. In some embodiments, the reverse time demigration models full arrivals of the received seismic data. In certain embodiments, the instructions, when executed by the one or more processors, further configure the one or more processors to (e) apply a numerical algorithm of full wave-equation to estimate seismic data of the subsurface region. In other embodiments, the numerical algorithm comprises a finite difference method (FDM) algorithm. In some embodiments, iteratively repeating (e.g., in sequential order) the steps (c)-(h) until the residual seismic data of a final iteration achieves a predefined magnitude comprises comparing the modeled seismic data to the observed seismic data such that the output seismic image of the subsurface region is iteratively shifted towards the observed seismic data. In certain embodiments, the migrated seismic image comprises an image gather and a stacked image.

In an embodiment, a computer-implemented method for generating a seismic image representative of a subsurface region comprises (a) receiving observed seismic data from the subsurface region captured by one or more seismic receivers as one or more reflected seismic signals; (b) performing, using a Kirchhoff migration operator, adjoint modeling on the observed seismic data to determine a migrated seismic image; (c) performing reverse-time demigration on the migrated seismic image, using a full wave-equation, to produce modeled seismic data representative of the subsurface region; (d) comparing the modeled seismic data with the observed seismic data to determine residual seismic data; (e) performing, using the Kirchhoff migration operator, adjoint modeling on the residual seismic data to determine one or more seismic gradients; (f) applying the one or more seismic gradients to the migrated seismic image to produce an updated seismic image; and (g) stacking the updated seismic image to produce a seismic image representative of the subsurface region. In some embodiments, the full wave-equation models full arrivals of the received seismic data. In certain embodiments, the method further comprises (h) applying a numerical algorithm to a velocity model of the subsurface region to determine a solved full wave-equation of the subsurface region. In other embodiments, the numerical algorithm comprises a finite difference method (FDM) algorithm.

### BRIEF DESCRIPTION OF THE DRAWINGS

For a detailed description of various exemplary embodiments, reference will now be made to the accompanying drawings in which:

FIG. 1 is a flow chart of various processes that may be performed based on analysis of seismic data acquired via a seismic survey system in accordance with principles disclosed herein;

FIG. 2 is a schematic diagram of an embodiment of a system for performing a marine seismic survey in accordance with principles disclosed herein;

FIG. 3 is a schematic diagram of an embodiment of a system for performing a land-based seismic survey in accordance with principles disclosed herein;

FIG. 4 is a block diagram of an embodiment of a computer system that may perform operations described herein based on data acquired via the marine survey system of FIG. 2 and/or the land survey systems of FIG. 3 in accordance with principles disclosed herein;

FIG. 5 is a flowchart illustrating operation of a least-squares wave-equation Kirchhoff migration in accordance with principles disclosed herein;

FIG. 6 is a flowchart of an embodiment of a method for least-squares wave-equation Kirchhoff migration in accordance with principles disclosed herein; and

FIG. 7 is a flowchart of another embodiment of a method for least-squares wave-equation Kirchhoff migration in accordance with principles disclosed herein.

### DETAILED DESCRIPTION

The following discussion is directed to various exemplary embodiments. However, one skilled in the art will understand that the examples disclosed herein have broad application, and that the discussion of any embodiment is meant only to be exemplary of that embodiment, and not intended to suggest that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in the interest of clarity and conciseness.

In the following discussion and in the claims, the terms “including” and “comprising” are used in an open-ended fashion, and thus should be interpreted to mean “including, but not limited to . . . ” Also, the term “couple” or “couples” is intended to mean either an indirect or direct connection. Thus, if a first device couples to a second device, that connection may be through a direct connection of the two devices, or through an indirect connection that is established via other devices, components, nodes, and connections. In addition, as used herein, the terms “axial” and “axially” generally mean along or parallel to a particular axis (e.g., central axis of a body or a port), while the terms “radial” and “radially” generally mean perpendicular to a particular axis. For instance, an axial distance refers to a distance measured along or parallel to the axis, and a radial distance means a distance measured perpendicular to the axis. As used herein, the terms “approximately,” “about,” “substantially,” and the like mean within 10% (i.e., plus or minus 10%) of the recited value. Thus, for example, a recited angle of “about 80 degrees” refers to an angle ranging from 72 degrees to 88 degrees.

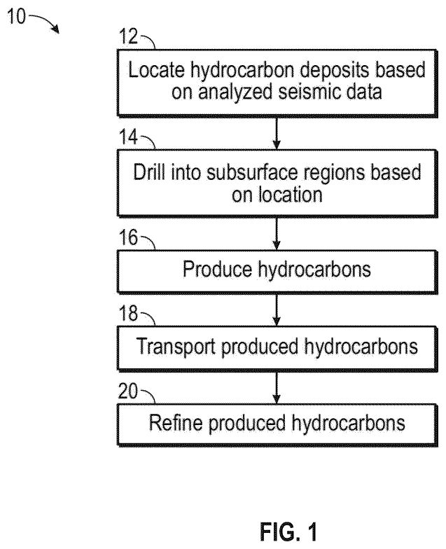

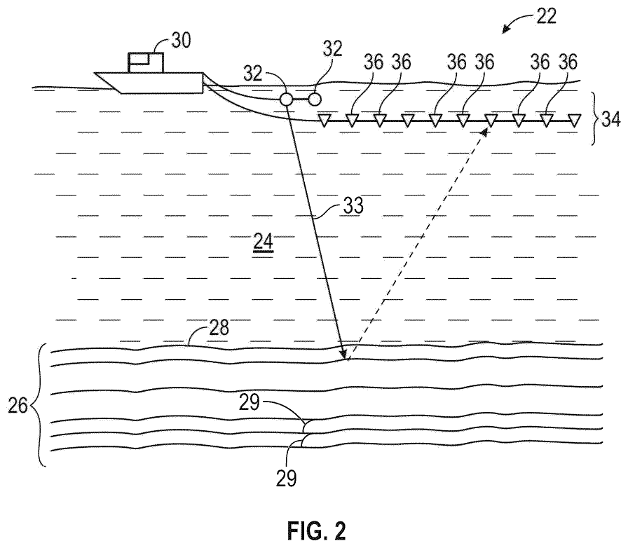

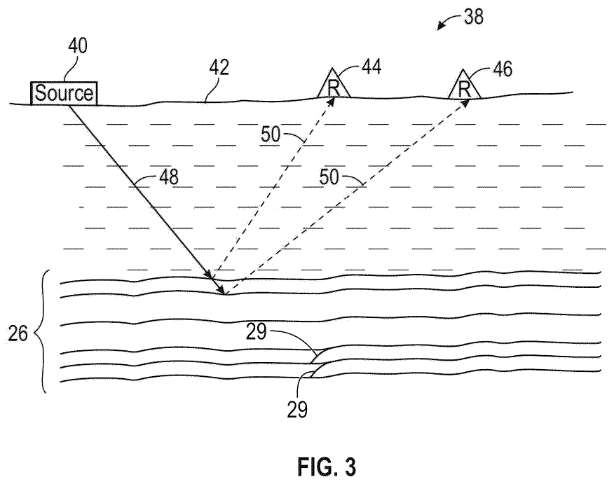

By way of introduction, seismic data may be acquired using a variety of seismic survey systems and techniques, two of which are discussed with respect to FIG. 2 and FIG. 3. Regardless of the seismic data gathering technique utilized, after the seismic data is acquired, a computing system may analyze the acquired seismic data and may use the results of the seismic data analysis (e.g., seismogram, map of geological formations, etc.) to perform various operations within the hydrocarbon exploration and production industries. For instance, FIG. 1 illustrates a flow chart of a method 10 that details various processes that may be undertaken based on the analysis of the acquired seismic data. Although the method 10 is described in a particular order, it should be noted that the method 10 may be performed in any suitable order.

Referring now to FIG. 1, at block 12, locations and properties of hydrocarbon deposits within a subsurface region of the Earth associated with the respective seismic survey may be determined based on the analyzed seismic data. In one embodiment, the seismic data acquired may be analyzed to produce a map or profile that illustrates various geological formations within the subsurface region. Based on the identified locations and properties of the hydrocarbon deposits, at block 14, certain positions or parts of the subsurface region may be explored. That is, hydrocarbon exploration organizations may use the locations of the hydrocarbon deposits to determine locations at the surface of the subsurface region to drill into the Earth. As such, the hydrocarbon exploration organizations may use the locations and properties of the hydrocarbon deposits and the associated overburdens to determine a path along which to drill into the Earth, how to drill into the Earth, and the like.

After exploration equipment has been placed within the subsurface region, at block 16, the hydrocarbons that are stored in the hydrocarbon deposits may be produced via natural flowing wells, artificial lift wells, and the like. At block 18, the produced hydrocarbons may be transported to refineries and the like via transport vehicles, pipelines, and the like. At block 20, the produced hydrocarbons may be processed according to various refining procedures to develop different products using the hydrocarbons.

It should be noted that the processes discussed with regard to the method 10 may include other suitable processes that may be based on the locations and properties of hydrocarbon deposits as indicated in the seismic data acquired via one or more seismic survey. As such, it should be understood that the processes described above are not intended to depict an exhaustive list of processes that may be performed after determining the locations and properties of hydrocarbon deposits within the subsurface region.

With the foregoing in mind, FIG. 2 is a schematic diagram of a marine survey system 22 (e.g., for use in conjunction with block 12 of FIG. 1) that may be employed to acquire seismic data (e.g., waveforms) regarding a subsurface region of the Earth in a marine environment. Generally, a marine seismic survey using the marine survey system 22 may be conducted in an ocean 24 or other body of water over a subsurface region 26 of the Earth that lies beneath a seafloor 28.

The marine survey system 22 may include a vessel 30, one or more seismic sources 32, a (seismic) streamer 34, one or more (seismic) receivers 36, and/or other equipment that may assist in acquiring seismic images representative of geological formations within a subsurface region 26 of the Earth. The vessel 30 may tow the seismic source(s) 32 (e.g., an air gun array) that may produce energy, such as sound waves (e.g., seismic waveforms), that is directed at a seafloor 28. The vessel 30 may also tow the streamer 34 having a receiver 36 (e.g., hydrophones) that may acquire seismic waveforms that represent the energy output by the seismic source(s) 32 subsequent to being reflected off of various geological formations (e.g., salt domes, faults, folds, etc., represented schematically in FIG. 2 as subsurface reflectors 29) within the subsurface region 26. Additionally, although the description of the marine survey system 22 is described with one seismic source 32 (represented in FIG. 2 as an air gun array) and one receiver 36 (represented in FIG. 2 as a set of hydrophones), it should be noted that the marine survey system 22 may include multiple seismic sources 32 and multiple receivers 36. In the same manner, although the above descriptions of the marine survey system 22 is described with one seismic streamer 34, it should be noted that the marine survey system 22 may include multiple streamers similar to streamer 34. In addition, additional vessels 30 may include additional seismic source(s) 32, streamer(s) 34, and the like to perform the operations of the marine survey system 22.

FIG. 3 is a block diagram of a land survey system 38 (e.g., for use in conjunction with block 12 of FIG. 1) that may be employed to obtain information regarding the subsurface region 26 of the Earth in a non-marine environment. The land survey system 38 may include a land-based seismic source 40 and land-based receiver 44. In some embodiments, the land survey system 38 may include multiple land-based seismic sources 40 and one or more land-based receivers 44 and 46. Indeed, for discussion purposes, the land survey system 38 includes a land-based seismic source 40 and two land-based receivers 44 and 46. The land-based seismic source 40 (e.g., seismic vibrator) that may be disposed on a surface 42 of the Earth above the subsurface region 26 of interest. The land-based seismic source 40 may produce energy (e.g., sound waves, seismic waveforms) that is directed at the subsurface region 26 of the Earth. Upon reaching various geological formations (e.g., salt domes, faults, folds) within the subsurface region 26 the energy output by the land-based seismic source 40 may be reflected off of the geological formations (e.g., subsurface reflectors 29) and acquired or observed by one or more land-based receivers (e.g., 44 and 46).

In some embodiments, the land-based receivers 44 and 46 may be dispersed across the surface 42 of the Earth to form a grid-like pattern. As such, each land-based receiver 44 or 46 may receive a reflected seismic waveform in response to energy being directed at the subsurface region 26 via the seismic source 40. In some cases, one seismic waveform produced by the seismic source 40 may be reflected off of different geological formations and received by different receivers. For example, as shown in FIG. 3, the seismic source 40 may output energy that may be directed at the subsurface region 26 as seismic waveform 48. A first receiver 44 may receive the reflection of the seismic waveform 48 off of one geological formation and a second receiver 46 may receive the reflection of the seismic waveform 48 off of a different geological formation. As such, the first receiver 44 may receive a reflected seismic waveform 50 and the second receiver 46 may receive a reflected seismic waveform 52.

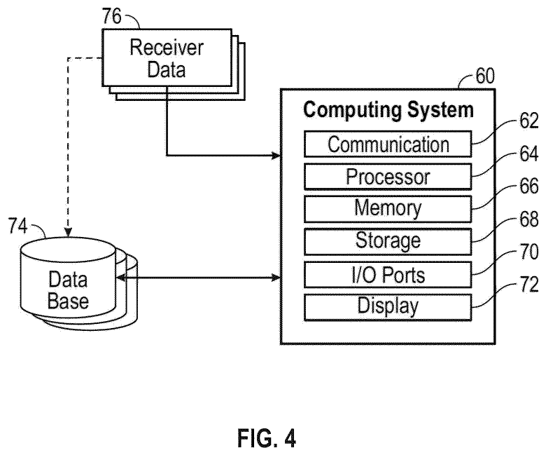

Regardless of how the seismic data is acquired, a computing system (e.g., for use in conjunction with block 12 of FIG. 1) may analyze the seismic waveforms acquired by the receivers 36, 44, 46 to determine or produce seismic information regarding the geological structure, the location and property of hydrocarbon deposits, and the like within the subsurface region 26. FIG. 4 is a block diagram of an example of such a computing system 60 that may perform various data analysis operations to analyze the seismic data acquired by the receivers 36, 44, 46 to determine the structure and/or predict seismic properties of the geological formations within the subsurface region 26.

Referring now to FIG. 4, the computing system 60 may include a communication component 62, a processor 64, memory 66, storage 68, input/output (I/O) ports 70, and a display 72. In some embodiments, the computing system 60 may omit one or more of the display 72, the communication component 62, and/or the input/output (I/O) ports 70. The communication component 62 may be a wireless or wired communication component that may facilitate communication between the receivers 36, 44, 46, one or more databases 74, other computing devices, and/or other communication capable devices. In one embodiment, the computing system 60 may receive receiver data 76 (e.g., seismic data, seismograms, etc.) via a network component, the database 74, or the like. The processor 64 of the computing system 60 may analyze or process the receiver data 76 to ascertain various features regarding geological formations within the subsurface region 26 of the Earth.

The processor 64 may be any type of computer processor or microprocessor capable of executing computer-executable code. The processor 64 may also include multiple processors that may perform the operations described below. The memory 66 and the storage 68 may be any suitable articles of manufacture that can serve as media to store processor-executable code, data, or the like. These articles of manufacture may represent computer-readable media (e.g., any suitable form of memory or storage) that may store the processor-executable code used by the processor 64 to perform the presently disclosed techniques. Generally, the processor 64 may execute software applications that include programs that process seismic data acquired via receivers of a seismic survey according to the embodiments described herein.

With one or more embodiments, processor 64 can instantiate or operate in conjunction with one or more seismic inversion techniques. With another embodiment, the computing system 60 can be implemented by using neural networks. The one or more neural networks can be software-implemented or hardware-implemented. One or more of the neural networks can be a convolutional neural network.

The memory 66 and the storage 68 may also be used to store the data, analysis of the data, the software applications, and the like. The memory 66 and the storage 68 may represent non-transitory computer-readable media (e.g., any suitable form of memory or storage) that may store the processor-executable code used by the processor 64 to perform various techniques described herein. It should be noted that non-transitory merely indicates that the media is tangible and not a signal.

The I/O ports 70 may be interfaces that may couple to other peripheral components such as input devices (e.g., keyboard, mouse), sensors, input/output (I/O) modules, and the like. I/O ports 70 may enable the computing system 60 to communicate with the other devices in the marine survey system 22, the land survey system 38, or the like via the I/O ports 70.

The display 72 may depict visualizations associated with software or executable code being processed by the processor 64. In one embodiment, the display 72 may be a touch display capable of receiving inputs from a user of the computing system 60. The display 72 may also be used to view and analyze results of the analysis of the acquired seismic data to determine the geological formations within the subsurface region 26, the location and property of hydrocarbon deposits within the subsurface region 26, predictions of seismic properties associated with one or more wells in the subsurface region 26, and the like. The display 72 may be any suitable type of display, such as a liquid crystal display (LCD), plasma display, or an organic light emitting diode (OLED) display, for example. In addition to depicting the visualization described herein via the display 72, it should be noted that the computing system 60 may also depict the visualization via other tangible elements, such as paper (e.g., via printing) and the like.

With the foregoing in mind, the present techniques described herein may also be performed using a supercomputer that employs multiple computing systems 60, a cloud-computing system, or the like to distribute processes to be performed across multiple computing systems 60. In this case, each computing system 60 operating as part of a super computer may not include each component listed as part of the computing system 60. For example, each computing system 60 may not include the display 72 since multiple displays 72 may not be useful to for a supercomputer designed to continuously process seismic data.

After performing various types of seismic data processing, the computing system 60 may store the results of the analysis in one or more databases 74. The databases 74 may be communicatively coupled to a network that may transmit and receive data to and from the computing system 60 via the communication component 62. In addition, the databases 74 may store information regarding the subsurface region 26, such as previous seismograms, geological sample data, seismic images, and the like regarding the subsurface region 26.

Although the components described above have been discussed with regard to the computing system 60, it should be noted that similar components may make up the computing system 60. Moreover, the computing system 60 may also be part of the marine survey system 22 or the land survey system 38 and thus may monitor and control certain operations of the seismic sources 32 or 40, the receivers 36, 44, 46, and the like. Further, it should be noted that the listed components are provided as example components and the embodiments described herein are not to be limited to the components described with reference to FIG. 4.

In some embodiments, the computing system 60 may produce a two-dimensional representation or a three-dimensional representation of the subsurface region 26 based on the seismic data received via the receivers mentioned above. Additionally, seismic data associated with multiple source/receiver combinations may be combined to create a near continuous profile of the subsurface region 26 that can extend for some distance. In a two-dimensional (2-D) seismic survey, the receiver locations may be placed along a single line, whereas in a three-dimensional (3-D) survey the receiver locations may be distributed across the surface in a grid pattern. As such, a 2-D seismic survey may provide a cross-sectional picture (vertical slice) of the Earth layers as they exist directly beneath the recording locations. A 3-D seismic survey, on the other hand, may create a data “cube” or volume that may correspond to a 3-D picture of the subsurface region 26.

In addition, a 4-D (or time-lapse) seismic survey may include seismic data acquired during a 3-D survey at multiple times. Using the different seismic images acquired at different times, the computing system 60 may compare the two images to identify changes in the subsurface region 26.

In any case, a seismic survey may be composed of a very large number of individual seismic recordings or traces. As such, the computing system 60 may be employed to analyze the acquired seismic data to obtain an image representative of the subsurface region 26 and to determine locations and properties of hydrocarbon deposits. To that end, a variety of seismic data processing algorithms may be used to remove noise from the acquired seismic data, migrate the pre-processed seismic data, identify shifts between multiple seismic images, align multiple seismic images, and the like.

After the computing system 60 analyzes the acquired seismic data, the results of the seismic data analysis (e.g., seismogram, seismic images, map of geological formations, etc.) may be used to perform various operations within the hydrocarbon exploration and production industries. For instance, as described above, the acquired seismic data may be used to perform the method 10 of FIG. 1 that details various processes that may be undertaken based on the analysis of the acquired seismic data.

As described above, seismic surveys reflect seismic waves off of features of earthen subsurface regions in order to collect information regarding the subsurface regions. The information collected from the reflected seismic waves may be used to create velocity models and seismic images which may be used to identify subterranean features of interest such as, for example, hydrocarbon deposits.

Seismic imaging typically includes a two-step process. First, a velocity model of the subsurface region is estimated. Then, seismic traces obtained from a seismic survey are combined with the estimated velocity model to produce an image of the subsurface structure using migration or imaging algorithms. As used herein, “migration” refers to a seismic data processing technique which shift or relocate seismic reflections captured in the observed seismic data to or at least towards their true physical positions in the subsurface region to create an image. As used herein, “observed seismic data” refers to data that is captured by one or more seismic receivers as seismic signals reflected by the subsurface region and which are originally produced by one or more corresponding sources. In some applications, an iterative data-fitting process such as a full waveform inversion (FWI) process may be applied to observed seismic data (e.g., seismic data collected using a seismic survey system such as survey systems 22 and 38) to form a velocity model therefrom. An FWI process may begin with an initial estimate of a velocity model and observed seismic data. The method can create a synthetic model based on a geometry of the observed seismic data and the velocity model to produce modeled seismic data, which the method can then compare with the corresponding observed seismic data. The velocity model is then updated using a data misfit, and the process can repeat. The iterations can terminate when the magnitude of the misfit between the modeled and observed seismic data becomes sufficiently small.

More particularly, various existing seismic data migration methods are employed in geophysics. These methods are particularly valuable in hydrocarbon exploration for structurally characterizing or describing subsurface regions (e.g., subsurface reservoirs) and identifying hydrocarbon bearing formations or other salient subsurface features contained therein. However, seismic images derived from conventional imaging techniques may encounter various challenges that compromise efficiency, as well as the accuracy and reliability of the resulting images.

For example, Kirchhoff migration is a technique that is widely used for generating an image of a subsurface region. Kirchhoff migration is based on the principles of wave propagation described by Kirchhoff's diffraction theory. The method traditionally uses a simplification of the full wave-equation to compute traveltimes along ray paths from the source to the reflectors and back to the receivers making the migration approach simpler and faster. Particularly, Kirchhoff migration may include stacking the observed seismic data along traveltime curves that correspond to the traveltimes calculated in the previous step and applying an imaging condition to the summed data to construct the final image. In this manner, the observed seismic data is integrated over diffraction travel paths as determined by an appropriate traveltime function (e.g., mapping the traveltime between source, reflector, and receiver) without requiring “solving” of the full wave-equation.

Kirchhoff migration, while being relatively straightforward and convenient to implement relative to other migration techniques (e.g., may be less demanding computationally than other techniques), may not fully capture the features of relatively complex subsurface structures, especially in areas with lateral variation or lack the resolution required for accurate interpretation. For example, standard “forward modeling” or demigration using a Kirchhoff migration operator usually includes only the single highest-energy arrival using traveltimes alone. By selecting the highest energy, the Kirchhoff migration operator may miss or underrepresent weaker arrivals and reflections that contain valuable information about the subsurface structure. As used herein, “demigration” refers to a data processing technique which reverses the seismic migration such that, the migrated seismic image is transformed back into its pre-migrated state. Additionally, seismic datasets used in migration are usually very large, consisting for example, tens of thousands of seismic traces. Kirchhoff migration requires accessing and processing these large volumes of data multiple times during the migration process, making the computation more time consuming and costly.

Further, seismic images derived from Kirchhoff migration may be susceptible to artifacts or require relatively extensive and computationally demanding post-processing in order to accurately represent the subsurface region and characterize the reservoir. For example, a Kirchhoff migration process may exhibit low performance in numerical implementations due to the need to describe and implement the adjoint operator used to protect the Kirchhoff migration operator from aliasing effects. “Aliasing” occurs when the migration operator introduces artifacts into the migrated image. This phenomenon occurs when the spatial sampling of the seismic data is too coarse and/or the migration operator dip is high. Such aliasing can obscure geological features, lead to inaccurate conclusions, as correlated events may appear unrelated, especially in areas with complex subsurface structure or noisy data. Aliasing may be avoided for example, by interpolating input data to a denser grid or applying anti-aliasing filters.

Conventionally, least-squares migration (LSM) and similar enhanced seismic imaging techniques employ a velocity model of the subsurface region which may be utilized in subsequent analysis and investigation. Generally, LSM is an iterative technique for generating a seismic image in which seismic data collected from seismic nodes or sensors is iteratively compared with modeled seismic waveforms (e.g., produced by a model such as a velocity model of the subsurface region) to minimize the misfit between the observed seismic data and the modeled seismic data produced by the model. In other words, LSM is formulated as an inverse problem in which the goal is to find a model that best matches the observed seismic data by minimizing the least squares error between the observed seismic data and the modeled data produced from the model. This iterative process adjusts the parameters of the model (e.g., velocity and density parameters) until the modeled waveforms closely match the observed data across different frequencies and arrival times. Generally, LSM and similar techniques may produce higher-resolution and more accurate subsurface images compared to traditional Kirchhoff migration by minimizing the difference (misfit) between the observed seismic data and the modeled data whereby noise and other artifacts are attenuated. However, LSM is also generally more computationally demanding and time-consuming compared to traditional migration techniques like Kirchhoff migration due to its iterative nature.

Accordingly, embodiments for least-squares wave-equation Kirchhoff migration described herein leverage the full wave-equation to produce more accurate seismic data while using Kirchhoff migration operators with traveltime function. Particularly, the methods and systems disclosed herein includes demigrating, using the velocity model and full wave-equation solved with numerical methods including, for example, finite difference (i.e., reverse-time demigration), the Kirchhoff migrated seismic image to produce modeled seismic data representative of the subsurface region (i.e., seismic data that has been subjected to migration using corresponding migration operator). Embodiments disclosed herein use the full wave-equation in the modeling/demigration step, instead of Kirchhoff modeling with traveltime, to produce a more accurate and complete dataset that includes full arrivals. By contrast, conventional demigration using a Kirchhoff operator considers only the single highest-energy arrival based on traveltimes. By accounting for all arrivals, embodiments disclosed herein offer more accurate modeled data and improve the performance of LSM. Additionally, demigration using full wave-equation modeling eliminates the undesirable and inefficient requirement of implementing the adjoint operator of anti-aliasing used to protect the Kirchhoff migration operator from aliasing effects. Embodiments of the methods and systems disclosed herein utilize Kirchhoff migration to produce an initial image of the subsurface region and the full wave-equation solved with, for example, finite difference (reverse-time demigration), in the forward modeling/demigration step, making the process more computationally efficient.

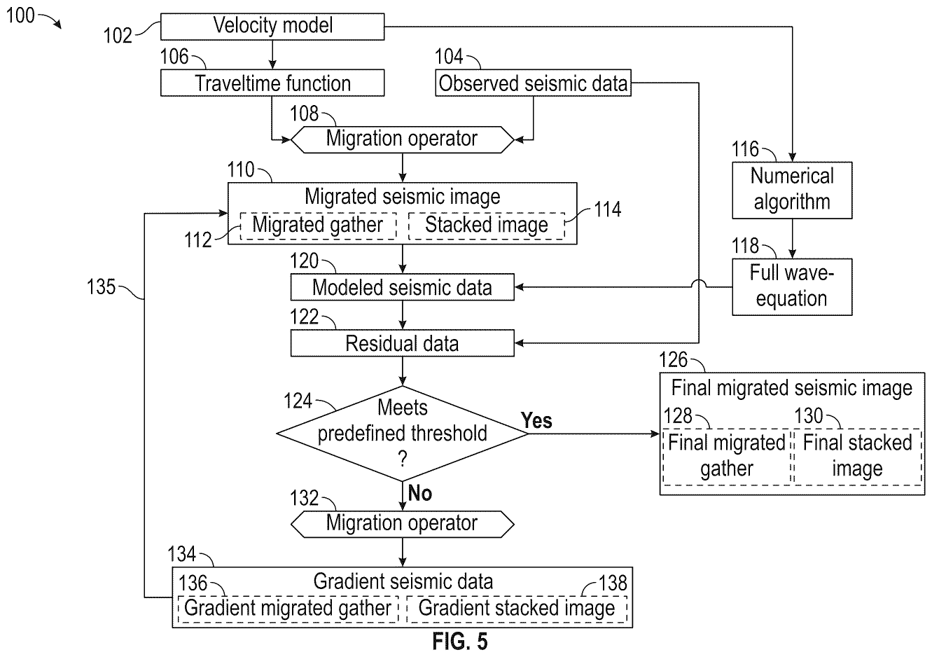

Referring now to FIG. 5, a flowchart 100 illustrating operation of least-squares wave-equation Kirchhoff migration using wave propagation in accordance with principles disclosed herein, is shown. At least some, if not all, of the steps or “blocks” of flowchart 100 shown in FIG. 5 may be executed by the computer system 60 shown in FIG. 4, although it may be understood that at least some of the steps of flowchart 100 may be executed by systems other than computer system 60. Additionally, it may be understood that the migration of seismic data described by flowchart 100 may be used for a variety of purposes, including volumetric analysis and in the planning of one or more wells which would extend through the subsurface region. Thus, an output of flowchart 100 such as final seismic data including final migrated seismic data may include, for example, final migrated seismic gathers and/or one or more final stacked seismic images of the subsurface region.

Beginning at block 102, a velocity model representative of the subsurface region is received. Not intending to be bound by any particular theory, the velocity model received at block 102 may be represented by the function “V (x)” where “x” represents a vector describing the subsurface position (e.g., in terms of spatial coordinates x, y, and/or z).

In some embodiments, the velocity model received at block 102 may be constructed using an iterative data-fitting process such as, for example, an FWI process applied to observed seismic data (e.g., seismic data collected using a seismic survey system such as survey systems 22 and 38). In some embodiments, flowchart 100 includes constructing an initial velocity model (received at block 102 thereof) of the subsurface region based on observed seismic data associated with the subsurface region (e.g., subsurface region 26 shown in FIGS. 2 and 3) and captured by one or more seismic receivers (e.g., seismic receivers 36, 44, and 46 shown in FIGS. 2 and 3). The velocity model models the velocity of the seismic waves passing through the subsurface region so as to translate subsurface reflection points of the seismic waves to their true depth within the formation. In some embodiments, the velocity model may be obtained in the form of normal moveout (NMO) velocity or by an inversion process such as in tomography or in FWI. Applying or implementing FWI processes to construct the velocity model of the subsurface region received at block 102 may comprise an iterative data-fitting processes in which an initial velocity model of the subsurface region is constructed and from which modeled seismic data may be produced. Additionally, the velocity model received at block 102 may comprise one or more associated model parameters that are updated iteratively.

At block 104, flowchart 100 includes receiving observed seismic data from the subsurface region captured by one or more seismic receivers as one or more reflected seismic signals. In some embodiments, the observed seismic data received at block 104 is used in forming the velocity model received at block 102 of flowchart 100 such as via the one or more processes (e.g., FWI processes) described above. The observed seismic data comprises reflected seismic data that, after being emitted from a seismic source (e.g., seismic sources 32 and 40), is reflected off of subsurface reflectors (e.g., subsurface reflectors 29 shown in FIGS. 2 and 3) formed in the subsurface region and subsequently captured by the one or more seismic receivers (e.g., seismic receivers 36, 44, and 46).

Not intending to be bound by any particular theory, the observed seismic data received at block 104 may be represented by the function Dr(s, g, t) where “s” represents a vector describing the location of the seismic source, “g” represents a vector describing the location of the seismic receiver, and “t” represents recording time.

As an example, in some embodiments, the seismic data received comprises observed seismic data in the form of seismic traces dₖ for each activation or shot k of one or more seismic sources (e.g., seismic sources 32 and 40) as observed or received by one or more corresponding seismic receivers (e.g., seismic receivers 36, 44, and 46). As described above, the seismic sources and/or seismic receivers may be spaced from one another resulting in the formation of varying reflection and/or azimuth angles between corresponding pairs of seismic sources and seismic receivers. Thus, each seismic trace dₖ may correspond to a specific reflection angle and a specific azimuth angle which may vary from the reflection and/or azimuth angles of other seismic traces dₖ. In addition, the seismic traces vary from the actual source wavelets aₖ (e.g., seismic waves 33, 48) produced by the seismic sources and may be unknown in at least some applications. Further, it may be understood that the seismic data may not be received or downloaded directly from the seismic sources themselves and instead may be received or downloaded from a separate storage medium or memory device.

At block 106, flowchart 100 includes determining, based on the velocity model received at block 102, a traveltime function associated with the subsurface region. Not intending to be bound by any particular theory, the traveltime function determined at block 106 may be represented by the function K(s, g, x, t) where “s” represents a vector describing the location of the seismic source, “g” represents a vector describing the location of the seismic receiver, and “x” represents a vector describing the subsurface position.

The traveltime function associated with the subsurface region generally characterizes the time required for a seismic wave to travel from a seismic source (e.g., seismic source 32, 40) to a subsurface reflector (e.g., subsurface reflectors 29) and a corresponding seismic receiver (e.g., 36, 44, 46). In this manner, traveltimes are computed to create a traveltime function (e.g., k(s, g, x, t)) using the velocity model (e.g., velocity model V(x)), and observed seismic data received at block 104 (e.g., observed seismic data Dr(s, g, t)). In some embodiments, the traveltime function comprises a single arrival traveltime function. The single arrival time traveltime function includes only the primary seismic wave (referred to sometimes as “P-waves”) that are the first received by a given seismic receiver and which represents the fastest path through the subsurface region. In other embodiments, the traveltime function may include some secondary seismic waves while still not corresponding to or otherwise capturing the full wave-equation. The traveltime function determined at block 106 may be computed using methods such as, for example, using ray tracing techniques (tracing the path of seismic rays through the velocity model received at block 102), picking arrivals from relatively low-frequency waves solved by finite difference techniques of the full wave-equation, and/or analytics techniques depending on the given application. In this exemplary embodiment, the traveltime function is estimated by picking the highest energy arrival from the full wave-equation modeling at relatively low frequencies. In this manner, the produced traveltimes are generally more accurate than the traveltimes calculated from ray tracing, and thus Kirchhoff migration with the traveltimes produce more accurate seismic image and image gathers.

Flowchart 100 continues at block 108 with applying a migration operator (e.g., a Kirchhoff migration operator) to the traveltime function and the observed seismic data received at block 104 to produce a migrated seismic image denoted at block 110 of method 100. In this manner, the migration operator applied at block 108 migrates, using the traveltime function determined at block 106, the observed seismic data received at block 102 to produce the migrated seismic image of block 110. In some embodiments, determining migrated seismic image at blocks 108 and 110 of method 100 comprises determining a migrated seismic image gather 112 and/or a migrated stacked image (or simply “stacked image”) 114. For migrated seismic image gather 112, different source-receiver offsets are kept separate while for stacked image 114 the images from each offset range are combined (e.g., summed). For example, and not intending to be bound by any particular theory, the migrated seismic image gather 112 may be represented by the function M′(x, h) where “h” represents the respective offset domain, and “x” represents a vector describing the subsurface location. Additionally, and again not intending to be bound by any particular theory, the stacked image 114 may be represented by the function M(x) where “x” similarly represents a vector describing the subsurface location.

In this exemplary embodiment, the migration operator of block 108 comprises a Kirchhoff migration operator. As previously described, the Kirchhoff migration operator is a seismic processing technique for migrating the seismic data (transforming observed seismic data into images of the subsurface) in which observed seismic data is integrated over diffraction travel paths as determined by an appropriate traveltime function (e.g., the traveltime function determined at block 106) as previously described. In some embodiments, applying the Kirchhoff migration operator at block 108 includes stacking the observed seismic data received at block 104 along different traveltime curves that correspond to the traveltimes calculated in the preceding step. In this manner, each point in the seismic image (e.g., the stacked image 114) is formed by summing contributions from all the traces that intersect at that point according to the calculated traveltimes and applying appropriate weighting factors for amplitude and phase correction provided by the Kirchhoff migration operator. Additionally, in some embodiments, an imaging condition is applied to the summed data.

At block 116, flowchart 100 includes applying a numerical algorithm at block 116 to the velocity model received at block 102 whereby a full wave-equation of the subsurface region is solved at block 118 (i.e., reverse-time demigration). In turn, the full wave-equation of block 118 may be applied or otherwise used to produce modeled seismic data denoted at block 120 of method 100. Not intending to be bound by any particular theory, the modeled seismic data 120 may be represented by the function Dc(s, g, t) where “s” represents a vector describing the location of the seismic source, “g” represents a vector describing the location of the seismic receiver, and “t” represents recording time.

In this exemplary embodiment, the full wave-equation of block 118 is solved through being estimated or approximated using numerical methods such as the numerical algorithm of block 116. In some embodiments, the numerical algorithm of block 116 to which the velocity model of block 102 is applied comprises a finite difference algorithm. For example, block 118 may include discretizing the full wave-equation into a form that can be solved numerically (e.g., discretizing time and space into discrete intervals or grids), following which the discretized full wave-equation may be approximated using finite differences. In some embodiments, the discretized full wave-equation may be updated iteratively using the finite difference approximations in order to solve or successfully approximate the full wave-equation. In certain applications, the finite difference algorithm approximates the derivatives in the full wave-equation using the values of the wavefield at neighboring grid points. In this embodiment, the wavefield may be initialized using the source wavelet introduced at the source location and propagated forward in time to solve the discretized full wave-equation. The time derivative of the wavefield may then be multiplied by a stacked seismic image to form secondary sources. These secondary sources initiate the receiver wavefield by solving the full wave-equation, and the modeled data is collected at the receiver positions. This process may be referred to as reverse-time demigration. In other embodiments, numerical algorithms other than finite difference algorithms may be utilized at block 116 for solving the full wave-equation of block 118 (e.g., the discretized full wave-equation) such as, for example, finite element methods in which polynomial functions approximate the wavefield within each of a plurality of shapes or elements, and spectral methods in which the full wave-equation is transformed into the frequency domain using an appropriate transform (e.g., a Fourier or Chebyshev transform). In other embodiments, the numerical algorithm of block 116 may include spectral element methods, discontinuous Galerkin methods, finite volume methods, pseudo spectral methods, and boundary element methods. Conventional LSM methods include performing Kirchhoff modeling using the traveltime function that is used for Kirchhoff migration operator, which is a formal adjoint symmetry of the forward and adjoint operator. For exact solution of large linear systems this would be detrimental to convergence. However, LSM is never taken all the way to formal convergence, iterations are stopped when a sufficiently high-quality result has been obtained and this usually happens in a few iterations (e.g., 10). In addition, by using a full wave-equation in the forward modeling step, a slight non-linearity is introduced into the process. This non-linearity increases the likelihood of generating more accurate images in complex velocity models and eliminates the requirement for the forward and adjoint operators to be true adjoints of one another.

The process of forward modeling the migrated seismic image of block 110 described above may comprise demigrating (e.g., returning the migrated seismic image of block 110 (e.g., migrated seismic gathers 112 and/or stacked images 114) to its original location in space or time) using the velocity model received at block 102 and the full wave-equation of the subsurface region solved at block 118. The full wave-equation models a significantly larger extent, if not the entirety, of the received seismic data (relative to the traveltime function determined at block 106) encompassing all or at least substantially all of the reflected seismic waves received by the seismic receiver(s) including reflections and other phenomena like refracted seismic waves. In other words, rather than modeling only the primary seismic reflected waves of highest energy arrival as with single traveltime functions, the full wave-equation may model all primary seismic reflected waves, multipaths, multiples, and other waves such as secondary or S-waves. While implementing a high-quality Kirchhoff migration operator (i.e., the “adjoint modeling” step described above) is relatively straightforward, implementing a high-quality forward modeling Kirchhoff operator is non-trivial and results in low-performance numerical implementations due to the need to describe and implement in computer code the adjoint of the methods used to protect the Kirchhoff migration operator from aliasing effects. If a full wave-equation is used as the forward modeling operator, this computational inconvenience is avoided given that finite difference solutions have aliasing protection automatically built in.

The full wave-equation may comprise the full acoustic anisotropic wave-equation of the subsurface region, the elastic anisotropic wave-equation of the subsurface region, or other forms of the full wave-equation. In some embodiments, demigrating at block 120 the migrated seismic image produced at block 110 includes forward modeling the migrated seismic image with a velocity model to produce the modeled seismic data.

At block 122, flowchart 100 includes comparing the modeled seismic data of block 120 with the observed seismic data received at block 104 to determine residual seismic data or simply “residual data.” The residual data of block 122 may also be referred to herein as the misfit or data mismatch. In some embodiments, determining residual data at block 122 comprises subtracting or otherwise determining a difference between the observed seismic data of block 104 and the modeled seismic data of block 120. At block 124, flowchart 100 comprises determining whether the residual data of block 122 (e.g., for a given iteration of flowchart 100 as will be discussed further herein) meets a predefined threshold such as, for example, a user specific magnitude. In response to the residual seismic data of block 122 meeting the predefined threshold, flowchart 100 includes determining final migrated seismic image at block 126 thereof. In some embodiments, the final migrated seismic image of block 126 includes one or more final migrated seismic gathers 128 and/or one or more final seismic (e.g., stacked) images 130. In some embodiments, determining the final migrated seismic image at block 126 includes taking the migrated seismic image of block 110 of the current iteration of flowchart 100 (as will be discussed further herein) as the final migrated seismic image of block 126 including, for instance, taking the migrated seismic gather 112 of the current iteration of flowchart 100 as the final migrated seismic gather 128 and/or taking the stacked image 114 of the current iteration of flowchart 100 as the final seismic image 130.

Conversely, should the residual seismic data 122 fail to meet the predefined threshold of block 124, flowchart 100 also includes applying a migration operator 132 to thereby migrate the residual seismic data of block 122 using the traveltime function determined at block 106 to determine one or more seismic gradients or simply “seismic gradient data” of block 134 of flowchart 100. In certain embodiments, the migration operator of block 132 comprises a Kirchhoff migration operator as described herein. In some embodiments, the migration operator of block 132 comprises the same migration operator as block 108.

In some embodiments, the one or more seismic gradients determined at block 134 may include gradient migrated gathers 136 and/or gradient stacked images 138. In certain embodiments, flowchart 100 may include determining a step-length (a) for minimizing the difference under a chosen norm of the observed seismic data received at block 104 and the modeled seismic data produced at block 120. In some embodiments, flowchart 100 includes applying, as part of a future or next iteration (i+1) of flowchart 100, the one or more seismic gradients of block 134 of the current iteration (i) of flowchart 100 to the migrated seismic image of block 110 of the current iteration (i) of flowchart 100 to produce an updated seismic image. Applying the one or more seismic gradients is performed by steepest descent methods, gradient methods, and the like. In some embodiments, flowchart 100 includes stacking the updated seismic image gather to produce a seismic image (e.g., final stacked seismic image 130) representative of the subsurface region.

In some embodiments, flowchart 100 includes iteratively repeating (indicated by arrow 135 in FIG. 5), in sequential order, blocks 110, 120, 122, 124, 132, and 134 of flowchart 100 described above, until the residual data of a final iteration achieves the predefined threshold of block 124 to determine final residual data whereby the seismic image of the final iteration corresponds to an output seismic image representative of the subsurface region.

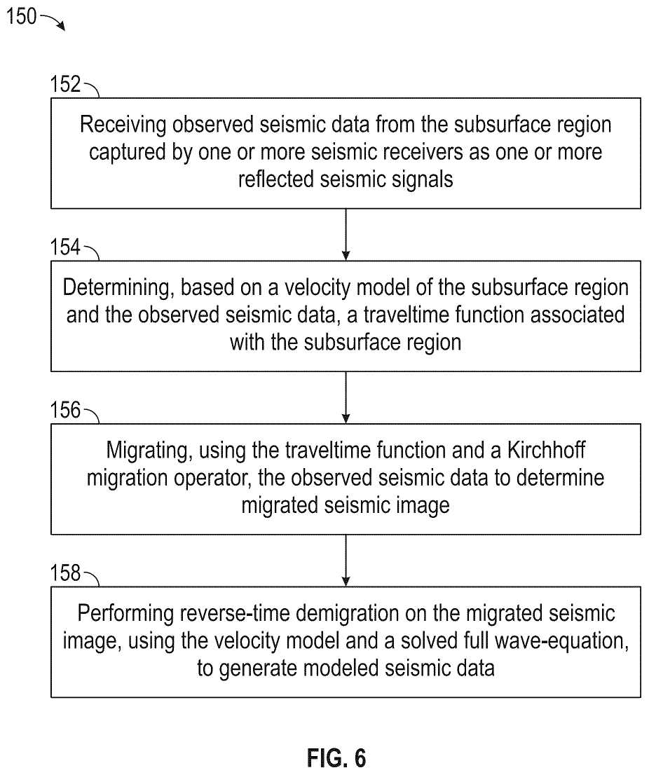

Referring now to FIG. 6, an embodiment of a method 150 for least-squares wave-equation Kirchhoff migration using wave propagation in accordance with principles disclosed herein, is shown. At least some, if not all, of the steps or “blocks” of method 150 shown in FIG. 6 may be executed by the computer system 60 shown in FIG. 4, although it is to be understood that at least some of the steps of method 150 may be executed by systems other than computer system 60. Additionally, it may be understood that the least squares migration of seismic data described by method 150 may be used for a variety of purposes, including volumetric analysis and in the planning of one or more wells which would extend through the subsurface region. Particularly, and as further discussed below, method 150 may incorporate at least some of the features or steps of flowchart 100 described above and shown in FIG. 5.

The method 150 begins at block 152, with receiving observed seismic data from the subsurface region captured by one or more seismic receivers as one or more reflected seismic signals. As previously described, the observed seismic data from the subsurface region is based on seismic data associated with the subsurface region (e.g., subsurface region 26 shown in FIGS. 2 and 3) and captured by one or more seismic receivers (e.g., seismic receivers 36, 44, and 46 shown in FIGS. 2 and 3). The observed seismic data comprises reflected seismic data that, after being emitted from a seismic source (e.g., seismic sources 32, and 40 shown in FIGS. 2 and 3), is reflected off of subsurface reflectors (e.g., subsurface reflectors 29 shown in FIGS. 2 and 3) formed in the subsurface region and subsequently captured by the one or more seismic receivers.

Method 150 continues at block 154 with determining, based on a velocity model of the subsurface region and the observed seismic data, a traveltime function associated with the subsurface region. As previously described, the traveltime function associated with the subsurface region generally characterizes the time required for a seismic wave to travel from a seismic source (e.g., seismic source 32, 40) to a subsurface reflector (e.g., subsurface reflectors 29) and a corresponding seismic receiver (e.g., seismic receivers 36, 44, 46). In some embodiments, the processes at block 154 of method 150 may be similar to those described at block 106 of flowchart 100, and includes for example, using ray tracing techniques (picking arrivals from relatively low-frequency waves compared to a maximum frequency for seismic migration, solved by finite difference techniques of full wave-equation). Generally, frequencies that are approximately 50% less than the maximum frequencies of seismic data are used. For example, a maximum of 10 Hertz (Hz) wave propagation may be used to extract traveltime function when migrating a maximum of 20 Hz data, or a maximum of 20 Hz wave propagation may be used when migrating a maximum of 40 Hz data. In some embodiments, ray tracing techniques and/or analytics techniques may be used to compute the traveltime function, depending on the given application.

At block 156, method 150 continues with migrating, using the traveltime function and a Kirchhoff migration operator, the observed seismic data to produce migrated a seismic image (i.e., transforming observed seismic data into images of the subsurface). In some embodiments, the processes executed at block 156 may be similar to the processes executed at block 108 of flowchart 100. The Kirchhoff migration operator applied at block 156 uses the traveltime function determined at block 154 and the observed seismic data received at block 152 to produce a migrated seismic image. In some embodiments, determining migrated seismic image at block 156 of method 150 comprises determining a migrated seismic gather (e.g., migrated seismic gather 112 of FIG. 5) and/or a migrated stacked image (e.g., migrated stacked image 114 of FIG. 5).

Method 150 continues at block 158 with performing reverse-time demigration (i.e., transforming migrated data into a pre-migrated state using time reversal) on the migrated seismic image, using the velocity model and a solved full wave-equation, to produce modeled seismic data representative of the subsurface region. In some embodiments, the processes executed at block 158 may be similar to the processes executed at block 116 through block 120 of flowchart 100. The full wave-equation may comprise a full acoustic anisotropic wave-equation, elastic anisotropic wave-equation or other forms of the full wave-equation, and may be solved using for example, numerical methods (finite difference, finite element) or spectral methods. For example, the computing system 60, in conjunction with block 158, may perform finite difference modeling (e.g., full 3D finite difference modeling) to produce the modeled seismic data. In other embodiments, numerical modeling other than finite difference modeling may be employed at block 158. In this manner, block 158 includes receipt of migrated seismic image from block 156. The computing system 60, in conjunction with block 158, operates by solving the full wave-equation to produce modeled seismic data (e.g., Dc(s, g, t)) representative of the subsurface region as an output at block 158. Thus, block 158 operates to produce modeled seismic data based upon the initial images (e.g., migrated gather 112 and staked images 14 of FIG. 5) received from block 156 to produce modeled seismic data based on the full wave-equation. In this manner, modeled seismic data are produced based on the processes undertaken at block 158.

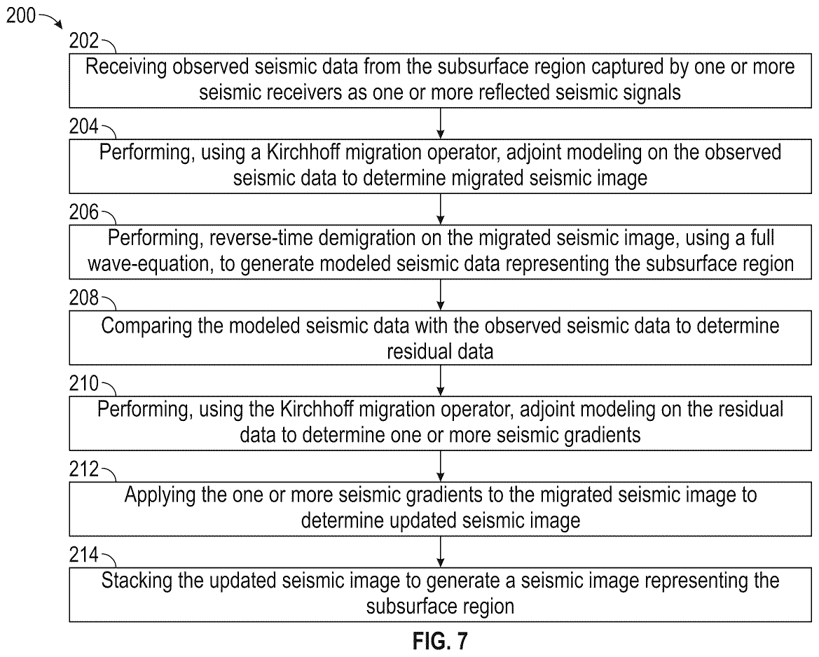

Referring now to FIG. 7, an embodiment of another method 200 for least-squares wave-equation Kirchhoff migration using wave propagation in accordance with principles disclosed herein, is shown. At least some, if not all, of the steps or “blocks” of method 200 shown in FIG. 7 may be executed by the computer system 60 shown in FIG. 4, although it is to be understood that at least some of the steps of method 200 may be executed by systems other than computer system 60. Additionally, it may be understood that the migration of seismic data described by method 200 may be used for a variety of purposes, including volumetric analysis and in the planning of one or more wells which would extend through the subsurface region. Particularly, and as further discussed below, method 200 may incorporate at least some of the features or steps of flowchart 100 and/or method 150 described above and shown in FIGS. 5 and 6.

The method 200 begins at block 202 with receiving observed seismic data from the subsurface region captured by one or more seismic receivers as one or more reflected seismic signals. As previously described, the observed seismic data from the subsurface region is based on seismic data associated with the subsurface region (e.g., subsurface region 26 shown in FIGS. 2 and 3) and captured by one or more seismic receivers (e.g., seismic receivers 36, 44, and 46 shown in FIGS. 2 and 3). The observed seismic data comprises reflected seismic data that, after being emitted from a seismic source (e.g., seismic sources 32, and 40 shown in FIGS. 2 and 3), is reflected off of subsurface reflectors (e.g., subsurface reflectors 29 shown in FIGS. 2 and 3) formed in the subsurface region and subsequently captured by the one or more seismic receivers.

At block 202 method 200 continues with performing, using a Kirchhoff migration operator, adjoint modeling on the observed seismic data to produce a migrated seismic image. Performing adjoint modeling on the observed seismic data to produce a migrated seismic image incudes using a traveltime function (e.g., k(s, g, x, t) and the observed seismic data (e.g., Dr(s, g, t)) to produce an estimate of the image of the subsurface both in gather form and as a stacked image (e.g., migrated gather 112 and stacked image 114 of FIG. 5). As previously described, the traveltime function is determined based on a velocity model of the subsurface region and the observed seismic data.

Method 200 continues at block 206 with performing reverse-time demigration on the migrated seismic image, using a full wave-equation, to produce modeled seismic data representative of the subsurface region. The process of reverse-time demigration using the migrated seismic image of block 204 may comprise demigrating (i.e., returning) the migrated seismic image of block 204 (e.g., migrated seismic gathers 112 and/or stacked images 114 of FIG. 5) to its original location in space and/or time using a velocity model representative of the subsurface region and the full wave-equation of the subsurface region. The full wave-equation may comprise a full acoustic anisotropic wave-equation, elastic anisotropic wave-equation or other forms of the full wave-equation, and may be solved using for example, numerical methods (finite difference, finite element) or spectral methods. For example, the computing system 60, in conjunction with block 206, may perform finite difference modeling (e.g., full 3D finite difference modeling) to produce the modeled seismic data. In other embodiments, forms of forward modeling other than finite difference modeling may be employed at block 206. In this manner, block 206 includes receipt of migrated seismic image from block 204. The computing system 60, in conjunction with block 206, operates by solving the full wave-equation to produce modeled seismic data (e.g., Dc (s, g, t)) representative of the subsurface region as an output at block 206. Thus, block 206 operates to generate modeled seismic data based upon the initial images (e.g., migrated gather 112 and stacked image 114 of FIG. 5) to produce modeled seismic data based upon the full wave-equation. In this manner, modeled seismic data are produced based on the processes undertaken at block 206. The modeled seismic data are then provided to block 208.

At block 208 method 200 continues with comparing the modeled seismic data with observed seismic data to determine residual data. The residual data determined at block 208 may also be referred to herein as the data mismatch or misfit. As previously described at block 122 of FIG. 5, determining residual data comprises determining a difference between the observed seismic data and the modeled seismic data, for example by subtracting or otherwise determining a difference between the observed seismic data of block 202 and the modeled seismic data of block 208.

Method 200 continues at block 210 with performing, using the Kirchhoff migration operator, adjoint modeling (back-propagating) on the residual data to determine one or more seismic gradients, in response to determining residual data fails to meet a predefined threshold. The seismic gradient determines the direction in which the model may be updated. At block 212, method 200 continues with applying the one or more seismic gradients to the migrated seismic data to determine updated seismic data. In this manner, the reflectivity values in the model are adjusted to better fit the observed seismic data and produce an updated seismic image.

In some embodiments, method 200 includes iteratively repeating (e.g., in sequential order) the steps of block 208 through 212 described above, until the residual data of a final iteration achieves a predefined magnitude to determine final residual data whereby the seismic image of the final iteration corresponds to an output seismic image representative of the subsurface region. At block 214, method 200 continues with stacking the updated seismic image to produce a seismic image representative of the subsurface region. The resulting stacked seismic image is a more accurate representation of the subsurface region.

While exemplary embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

What is claimed is:

1. A computer-implemented method for determining modeled seismic data associated with a subsurface region, the method comprising:
(a) receiving observed seismic data from a subsurface region captured by one or more seismic receivers as one or more reflected seismic signals;
(b) determining, based on a velocity model of the subsurface region and the observed seismic data, a traveltime function associated with the subsurface region;
(c) migrating, using the traveltime function and a Kirchhoff migration operator, the observed seismic data to produce a migrated seismic image; and
(d) performing reverse-time demigration on the migrated seismic image, using the velocity model and a solved full wave-equation, to produce modeled seismic data.

2. The method of claim 1, further comprising:
(e) comparing the modeled seismic data with the observed seismic data to determine residual seismic data; and
(f) migrating, using the traveltime function and the Kirchhoff migration operator, the residual seismic data to determine one or more seismic gradients.

3. The method of claim 2, further comprising:
(g) applying the one or more seismic gradients to the migrated seismic image to produce an updated seismic image; and
(h) stacking the updated seismic image to produce a seismic image representative of the subsurface region.

4. The method of claim 3, further comprising:
(i) iteratively repeating steps (c)-(h) until the residual seismic data of a final iteration achieves a predefined magnitude to determine final residual seismic data whereby the seismic image of the final iteration corresponds to an output seismic image representative of the subsurface region.

5. The method of claim 2, wherein (e) comprises determining a difference between the observed seismic data and the modeled seismic data.

6. The method of claim 1, wherein the traveltime function comprises a single-arrival traveltime function.

7. The method of claim 1, wherein the traveltime function is estimated by picking the highest energy arrival from the full wave-equation modeling.

8. The method of claim 1, wherein the reverse time demigration models full arrivals of the received seismic data.

9. The method of claim 1, further comprising:
(e) applying a numerical algorithm of full wave-equation to estimate seismic data of the subsurface region.

10. The method of claim 9, wherein the numerical algorithm comprises a finite difference method (FDM) algorithm.

11. The method of claim 4, wherein iteratively repeating the steps (c)-(h) until the residual seismic data of a final iteration achieves a predefined magnitude comprises comparing the modeled seismic data to the observed seismic data such that the output seismic image of the subsurface is iteratively shifted towards the observed seismic data.

12. The method of claim 1, wherein the migrated seismic image comprises an image gather and a stacked image.

13. A system comprising:
a one or more processors; and
a storage device coupled to the one or more processors, the storage device configured to store instructions that, when executed by the one or more processors, configure the one or more processors to:
(a) receive observed seismic data from a subsurface region captured by one or more seismic receivers as one or more reflected seismic signals;
(b) determine, based on a velocity model of the subsurface region and the observed seismic data, a traveltime function associated with the subsurface region;
(c) migrate, using the traveltime function and a Kirchhoff migration operator, the observed seismic data to produce a migrated seismic image; and
(d) perform reverse-time demigration on the migrated seismic image, using the velocity model and a solved full wave-equation, to produce modeled seismic data.

14. The system of claim 13, wherein the instructions, when executed by the one or more processors, further configure the one or more processors to:
(e) compare the modeled seismic data with the observed seismic data to determine residual seismic data; and
(f) migrate, using the traveltime function and the Kirchhoff migration operator, the residual seismic data to determine one or more seismic gradients.

15. The system of claim 14, wherein the instructions, when executed by the one or more processors, further configure the one or more processors to:
(g) apply the one or more seismic gradients to the migrated seismic image to produce an updated seismic image; and
(h) stack the updated seismic image to produce a seismic image representative of the subsurface region.

16. The system of claim 14, wherein the instructions, when executed by the one or more processors, further configure the one or more processors to:
(i) iteratively repeat steps (c)-(h) until the residual seismic data of a final iteration achieves a predefined magnitude to determine final residual seismic data whereby the seismic image of the final iteration corresponds to an output seismic image representative of the subsurface region.

17. The system of claim 14, wherein (e) comprises determining a difference between the observed seismic data and the modeled seismic data.

18. The system of claim 13, wherein the traveltime function comprises a single-arrival traveltime function.

19. The system of claim 13, wherein the traveltime function is estimated by picking the highest energy arrival from the full wave-equation modeling.

20. The system of claim 13, wherein the reverse time demigration models full arrivals of the received seismic data.

21. The system of claim 13, wherein the instructions, when executed by the one or more processors, further configure the one or more processors to:
(e) apply a numerical algorithm of full wave-equation to estimate seismic data of the subsurface region.

22. The system of claim 21, wherein the numerical algorithm comprises a finite difference method (FDM) algorithm.

23. The system of claim 16, wherein iteratively repeating the steps (c)-(h) until the residual seismic data of a final iteration achieves a predefined magnitude comprises comparing the modeled seismic data to the observed seismic data such that the output seismic image of the subsurface is iteratively shifted towards the observed seismic data.

24. The system of claim 13, wherein the migrated seismic image comprises an image gather and a stacked image.

25. A computer-implemented method for generating a seismic image representative of a subsurface region, the method comprising:
(a) receiving observed seismic data from the subsurface region captured by one or more seismic receivers as one or more reflected seismic signals;
(b) performing, using a Kirchhoff migration operator, adjoint modeling on the observed seismic data to produce a migrated seismic image;
(c) performing reverse-time demigration on the migrated seismic image, using a full wave-equation, to produce modeled seismic data representative of the subsurface region;
(d) comparing the modeled seismic data with the observed seismic data to determine residual seismic data;
(e) performing, using the Kirchhoff migration operator, adjoint modeling on the residual seismic data to determine one or more seismic gradients;
(f) applying the one or more seismic gradients to the migrated seismic image to produce an updated seismic image; and
(g) stacking the updated seismic image to produce a seismic image representative of the subsurface region.

26. The method of claim 25, wherein the full wave-equation models full arrivals of the received seismic data.

27. The method of claim 25, further comprising:
(h) applying a numerical algorithm to a velocity model of the subsurface region to determine a solved full wave-equation of the subsurface region.

28. The method of claim 27, wherein the numerical algorithm comprises a finite difference method (FDM) algorithm.
